(19) United States
(12) Patent Application Publication
(10) Pub. No.: US 2009/0153112 A1
(43) Pub. Date: Jun. 18, 2009

(54) LINEAR STEP-DOWN VOLTAGE REGULATOR

(75) Inventors: Chun-Hua Xia, Jiangsu Province (CN); Shih-Hao Liu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/021,936

(22) Filed: Jan. 29, 2008

(30) Foreign Application Priority Data
Dec. 14, 2007 (CN) 200710160902.1

(51) Int. Cl. G05F 1/10

(52) U.S. Cl. 323/280

(57) ABSTRACT

A linear step-down voltage regulator is provided. The linear step-down voltage regulator is grounded with a ground terminal. The ground terminal is electrically connected to a digital ground terminal of a switching circuit. The linear step-down voltage regulator includes a pass element, a voltage dividing resistor, an error amplifier, a metal oxide semiconductor (MOS) transistor, and a low-pass filter. The employment of the low-pass filter effectively adjusts and restricts the switching noise to pass therethrough, so as to decrease the output of the switching noise and thus eliminating the problems due to the noise.

### CROSS-REFERENCE TO RELATED APPLICATION

This application claims the priority benefit of China application serial no. 200710160902.1, filed on Dec. 14, 2007. The entirety of the above-mentioned patent application is hereby incorporated by reference herein and made a part of this specification.

### BACKGROUND OF THE INVENTION

1. Field of the Invention

The present invention generally relates to a linear step-down voltage regulator, and more particularly, to a linear step-down voltage regulator for lowering noises.

2. Description of Related Art

Linear step-down voltage regulators are required for some electronic apparatus, e.g., in a DC-DC power source conversion for a circuit board of a server. FIG. 1 is a circuit diagram illustrating a conventional linear step-down voltage regulator. FIG. 1 shows a linear step-down voltage regulator 100 generates an output voltage Vout via an input voltage Vin. The conventional linear step-down voltage regulator 100 works in conjunction with a switching circuit SC. The linear step-down voltage regulator 100 includes ground terminals which are analog ground terminals. The switching circuit SC includes a ground terminal AGND which is a digital ground terminal. Because there is a commonly used ground terminal between the linear step-down voltage regulator 100 and the switching circuit SC, besides the linear step-down voltage regulator 100 including a high-gain error amplifier ER, there is a switching noise generated and then passed through the common ground terminal and a reference voltage Vref, and then amplified by the error amplifier ER, and finally transmitted to the output of the step-down voltage regulator.

Said noise may cause misoperation of the error amplifier ER, and accordingly affect the control of the linear step-down voltage regulator 100 to the outputted voltage. Therefore, it is highly desirable to eliminate the affection caused by the switching noise.

### SUMMARY OF THE INVENTION

Accordingly, the present invention is directed to a linear step-down voltage regulator. The linear step-down voltage regulator includes a low-pass filter for adjusting a bandwidth and a roll-off frequency of the linear step-down voltage regulator, and for filtering a noise, so as to eliminate problems due to the noise.

The present invention provides a linear step-down voltage regulator. The linear step-down voltage regulator is grounded to a ground terminal. The ground terminal comprises an analog ground terminal. The ground terminal is electrically connected to a digital ground terminal of a switching circuit. The linear step-down voltage regulator includes a pass element, a voltage dividing resistor, an error amplifier, a metal oxide semiconductor (MOS) transistor, and a low-pass filter. The pass element includes an input terminal, an output terminal, and a control terminal. The input terminal of the pass element is coupled to a power supply. The voltage dividing resistor is coupled between the pass element and the ground terminal. An output voltage is generated at a location where the voltage dividing resistor and the pass element are coupled together. The voltage dividing resistor provides a feedback voltage which is directly proportional to the output voltage. The error amplifier includes a first input terminal, a second input terminal, and an output terminal. The first input terminal of the error amplifier receives the feedback voltage. The second input terminal of the error amplifier receives a reference voltage. The MOS transistor includes a gate, a source, and a drain. The gate of the MOS transistor is coupled to the output terminal of the error amplifier. The source of the MOS transistor is coupled to the ground terminal. The low-pass filter is coupled between the drain of the MOS transistor and the control terminal of the pass element for depressing a switching noise originated from the switching circuit.

According to an embodiment of the present invention, the low-pass filter includes a first resistor, and a first capacitor. The first resistor has an end coupled to the drain of the MOS transistor, and another end coupled to the control terminal of the pass element. The first capacitor has an end coupled to the drain of the MOS transistor, and another end coupled to the ground terminal. The first resistor and the first capacitor are employed for adjusting a bandwidth and a roll-off frequency of the linear step-down voltage regulator.

According to an embodiment of the present invention, the pass element further includes a second resistor, and a bipolar junction transistor (BJT). The second resistor has an end coupled to the input terminal of the pass element, and another end coupled to the control terminal of the pass element. The BJT includes a base coupled to the control terminal of the pass element, an emitter coupled to the input terminal of the pass element, and a collector coupled to the output terminal of the pass element.

According to an embodiment of the present invention, the pass element further includes a second capacitor coupled between the input terminal of the pass element and the ground terminal.

According to an embodiment of the present invention, the BJT is a PNP transistor.

According to an embodiment of the present invention, the pass element includes a P-type MOS transistor. The P-type MOS transistor includes a source, a drain and a gate. The source of the P-type MOS transistor is coupled to the input terminal of the pass element. The gate of the P-type MOS transistor is coupled to the control terminal of the pass element. The drain of the P-type MOS transistor is coupled to the output terminal of the pass element.

According to an embodiment of the present invention, the voltage dividing resistor includes a third resistor, and a fourth resistor. The third resistor has an end coupled to the output terminal of the pass element. The fourth resistor is coupled between another end of the third resistor and the ground terminal. The feedback voltage is provided at a location where the third resistor and the fourth resistor are coupled together.

According to an embodiment of the present invention, the voltage dividing resistor further includes a third capacitor coupled between the output terminal of the pass element and the ground terminal.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional linear step-down voltage regulator.

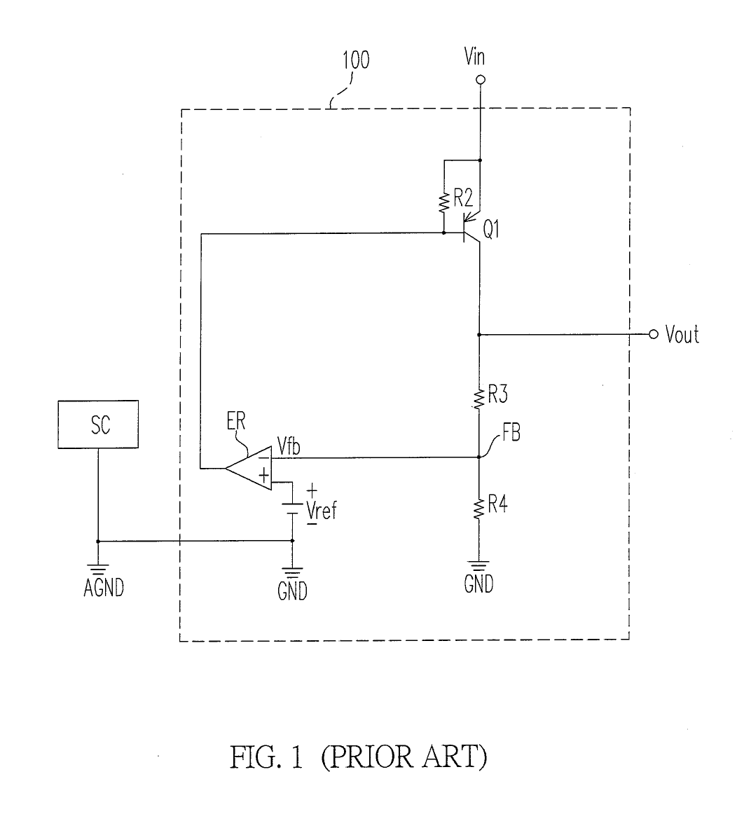

FIG. 2 is a circuit diagram of a linear step-down voltage regulator according to an embodiment of the present invention.

FIG. 3 is a circuit diagram of a linear step-down voltage regulator according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

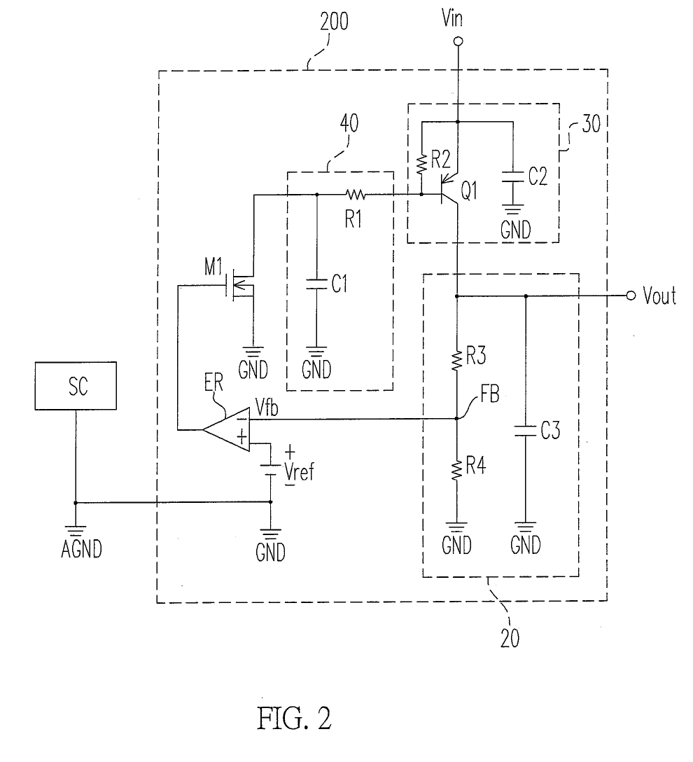

FIG. 2 is a circuit diagram of a linear step-down voltage regulator according to an embodiment of the present invention. Referring to FIG. 2, a linear step-down voltage regulator 200 is coupled to a switching circuit SC. The linear step-down voltage regulator 200 includes a plurality of ground terminals, all of which are analog grounds, and one of which is coupled to a digital ground AGND which is provided for the switching circuit SC. The linear step-down voltage regulator 200 includes a pass element 30, a voltage dividing resistor 20, an error amplifier ER, a MOS transistor M1, and a low-pass filter 40. The low-pass filter 40 is coupled between a drain of the MOS transistor M1 and a control terminal of the pass element 30 for depressing a switching noise originated from the switching circuit SC.

According to an aspect of the embodiment, the low-pass filter 40 is complied with a first order low-pass filter, in that for example the low-pass filter 40 is composed of a resistor R1 and a capacitor C1, so as to allow low frequency signals to pass therethrough and allow less signals which frequency are higher than a cut-off frequency threshold to pass therethrough. Generally, low-pass filters with different resistance/capacitance (RC) values correspond to different attenuation degrees of signals at different frequencies. The low-pass filter 40 is adapted for effectively eliminating output noises originated from the error amplifier ER.

According to another aspect of the embodiment of FIG. 2, the resistance of the resistor RI and the capacitance of the capacitor C1 of the low-pass filter 40 are adjusted according to a switching frequency of the switching circuit SC. In such a way, the RC value of the low-pass filter 40 can be adjusted. Upon the adjustment of the RC value of the low-pass filter 40, a bandwidth and a roll-off frequency of the linear step-down voltage regulator 200 are correspondingly changed, and thus the noise can be effectively eliminated. Details of the adjustment of the bandwidth and the roll-off frequency can be learnt by referring to reference books or articles, and are not to be iterated hereby.

There is a common ground terminal between the linear step-down voltage regulator 200 and the switching circuit SC, and the linear step-down voltage regulator 200 includes a high-gain error amplifier ER. Therefore even though the switching noise generated from the switching circuit SC can pass through the common ground terminal and a reference voltage Vref, and is then amplified by the error amplifier ER, the switching noise is filtered by the low-pass filter 40 before being finally transmitted to the output of the step-down voltage regulator 200. As such, the switching noise originated from the switching circuit SC can be effectively depressed.

According to an aspect of the embodiment, the pass element 30 includes an input terminal coupled to a power supply which provides an input voltage Vin, an output terminal coupled to the voltage dividing resistor 20. An output voltage Vout is outputted from where the output terminal of the pass element 30 and the voltage dividing resistor 20 are coupled together. When the input voltage Vin is relative small, the pass element 30 is sustained at an off status, and the adjustment of a voltage between the input terminal and the output terminal of the pass element is controllable. When the input voltage Vin rises to a certain value, the pass element 30 is turned on, and the output voltage Vout ascends till it stably reaches the preset value.

According to another embodiment of the present invention, the pass element 30 may further include a resistor R2 and a bipolar junction transistor (BJT) Q1. The BJT Q1 can be for example a PNP transistor. The resistor R2 has an end coupled to the input terminal of the pass element 30, and another end coupled a control terminal of the pass element 30. The BJT Q1 includes a base coupled to the control terminal of the pass element 30, an emitter coupled to the input terminal of the pass element 30, and a collector coupled to the output terminal of the pass element 30. Those skilled in the art may modify the pass element 30 by further including a capacitor C2 coupled between the input terminal of the pass element 30 and the ground terminal GND.

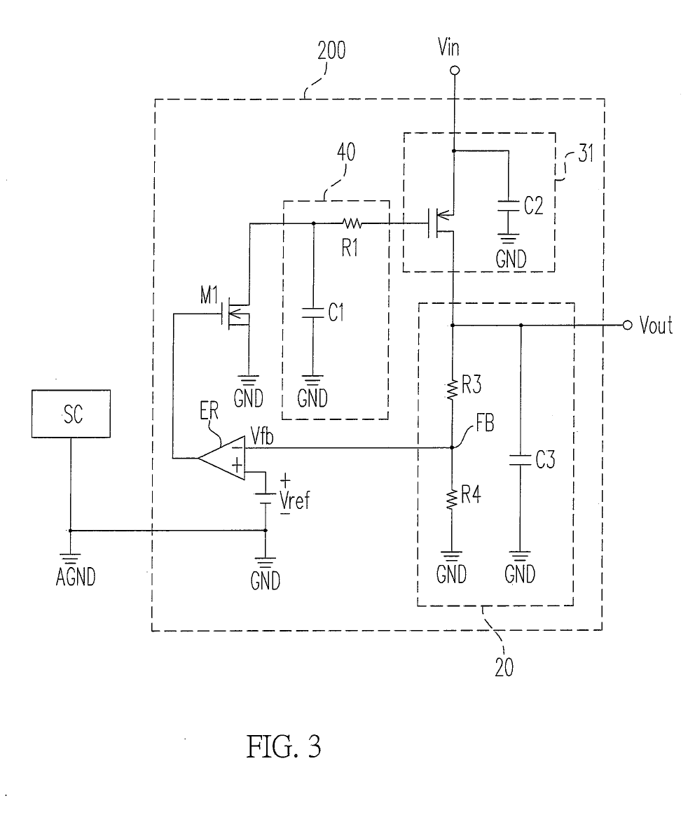

However, it should be noted that the pass element is not restricted as described above. Those of ordinary skill in the art may also comply with the pass element with a P-type MOS transistor. FIG. 3 is a circuit diagram of a linear step-down voltage regulator according to another embodiment of the present invention. Referring to FIG. 3, a pass element 31is coupled similar with the pass element 30 of FIG. 2. The P-type MOS transistor P1 includes a source, a drain, and a gate. The source of the P-type MOS transistor P1 is coupled to an input terminal of the pass transistor 31. The gate of the P-type MOS transistor P1 is coupled to a control terminal of the pass element 31. The drain of the P-type MOS transistor P1 is coupled to an output terminal of the pass element 31.

The circuit of the voltage dividing resistor 20 can be learnt by referring to FIG. 2 or FIG. 3, as described below.

The voltage dividing resistor 20 is coupled between the pass element 30 and the ground terminal GND for providing a feedback voltage Vfb which is directly proportional to the input voltage Vin. When the input voltage Vin varies, the feedback voltage Vfb varies correspondingly. The variation of the feedback voltage Vfb then passes the error amplifier ER, the MOS transistor M1, and the low-pass filter 40 for adjusting and controlling the output from the pass element 30, so as to control the output voltage Vout. As such an increment in an open circuit gain of the entire circuit would be very helpful for improving a linear regulation rate.

According to an embodiment of the present invention, the voltage dividing resistor 20 further includes resistors R3 and R4. The resistor R3 has an end coupled to the output terminal of the pass element 30. The resistor R4 is coupled between another end of the resistor R3 and the ground terminal GND. Resistors R3 and R4 are coupled together at a position FB from where the feedback Vfb is provided. Those skilled in the art may also modify the voltage dividing resistor 20 to further include a capacitor C3 coupled between the output terminal of the pass element 30 and the ground terminal GND.

In summary, the present invention employs the low-pass filter for effectively adjust and restrict the switching noise to pass therethrough, so as to decrease the output of the switching noise and thus eliminating the problems due to the noise, and therefore stably output the output voltage. The employment of the low-pass filter is simple and convenient, and therefore incurs a small additional cost and effectively eliminate the misoperation of the error amplifier caused by the noise, and stabilize the output of the linear step-down voltage regulator.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A linear step-down voltage regulator, being grounded to a plurality of analog ground terminals, the ground terminal being electrically connected to a digital ground terminal of a switching circuit, the linear step-down voltage regulator comprising:
a pass element, having an input terminal, an output terminal, and a control terminal, wherein the input terminal of the pass element is coupled to a power supply;
a voltage dividing resistor, coupled between the pass element and the ground terminal, wherein an output voltage is generated at a location where the voltage dividing resistor and the pass element are coupled together, and the voltage dividing resistor provides a feedback voltage is directly proportional to the output voltage;
an error amplifier, having a first input terminal, a second input terminal, and an output terminal, wherein the first input terminal of the error amplifier receives the feedback voltage, the second input terminal of the error amplifier receives a reference voltage;
a metal oxide semiconductor (MOS) transistor, having a gate, a source, and a drain, wherein the gate of the MOS transistor is coupled to the output terminal of the error amplifier, the source of the MOS transistor is coupled to the ground terminal; and
a low-pass filter, coupled between the drain of the MOS transistor and the control terminal of the pass element for depressing a switching noise originated from the switching circuit.

2. The linear step-down voltage regulator according to claim 1, wherein the low-pass filter comprises:
a first resistor, having an end coupled to the drain of the MOS transistor, and another end coupled to the control terminal of the pass element; and
a first capacitor, having an end coupled to the drain of the MOS transistor, and another end coupled to the ground terminal,
wherein the first resistor and the first capacitor are adapted for adjusting a bandwidth and a roll-off frequency of the linear step-down voltage regulator.

3. The linear step-down voltage regulator according to claim 1, wherein the pass element further comprises:
a second resistor, having an end coupled to the input terminal of the pass element, and another end coupled to the control terminal of the pass element; and
a bipolar junction transistor (BJT) having a base coupled to the control terminal of the pass element, an emitter coupled to the input terminal of the pass element, and a collector coupled to the output terminal of the pass element.

4. The linear step-down voltage regulator according to claim 3, wherein the pass element further comprises a second capacitor coupled between the input terminal of the pass element and the ground terminal.

5. The linear step-down voltage regulator according to claim 3, wherein the BJT is a PNP transistor.

6. The linear step-down voltage regulator according to claim 1, wherein the pass element comprises a P-type MOS transistor having a source, a drain and a gate, wherein the source of the P-type MOS transistor is coupled to the input terminal of the pass element, the gate of the P-type MOS transistor is coupled to the control terminal of the pass element, and the drain of the P-type MOS transistor is coupled to the output terminal of the pass element.

7. The linear step-down voltage regulator according to claim 1, wherein the voltage dividing resistor comprises:
a third resistor, having an end coupled to the output terminal of the pass element; and
a fourth resistor, coupled between another end of the third resistor and the ground terminal,
wherein the feedback voltage is provided at where the third resistor and the fourth resistor are coupled together.

8. The linear step-down voltage regulator according to claim 7, wherein the voltage dividing resistor further comprises a third capacitor coupled between the output terminal of the pass element and the ground terminal.
